(19) United States
(12) Patent Application Publication
(10) Pub. No.: US 2005/0106905 A1
(43) Pub. Date: May 19, 2005

(54) Land grid array connector assembly

(75) Inventor: Hao-Yun Ma, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND CO., LTD.

(21) Appl. No.: 10/982,310

(22) Filed: Nov. 5, 2004

(30) Foreign Application Priority Data
Nov. 14, 2003 (TW) 92220208

(51) Int. Cl. H01R 12/00

(52) U.S. Cl. 439/73

(57) ABSTRACT

A land grid array (LGA) connector assembly for electrically connecting with an electrical package comprises an insulative housing; a plurality of electrical contacts received in the housing; a reinforcement defining an aperture in middle thereof for exposing the soldering portions of the electrical contacts; a clip hinged with the reinforcement on a rear edge thereof and pivotable between an open position and a final position and the clip formed with at least a resilient portion projecting toward the insulative housing adjacent to the front edge thereof and a pressing portion curving toward the insulative housing at middle portion thereof along a front-rear direction; and a lever pivotally mounted in the reinforcement and comprising a securing portion for pressing the clip.

### BACKGROUND OF THE INVENTION

1. Field of the Invention

The present invention relates to land grid array (LGA) connector assemblies, and particularly to a LGA connector assembly adapted for receiving a LGA central processing unit (CPU) therein and electrically connecting the CPU with a printed circuit board (PCB). This application relates to a contemporaneously filed application having the same title, the applicant and the same assignee with the invention.

2. Description of Related Art

Referring to FIG. 5, a conventional LGA connector assembly 8 adapted for electrically connecting a LGA CPU 100 comprises an insulating housing 82 receiving a plurality of electrical contacts 81, a metal reinforcement 83, a metal clip 84 and a lever 86. The lever 86 comprises a securing portion 85 and the clip 84 comprises a lip 841 formed on a front edge (not shown) thereof. In conjunction with FIG. 6, the CPU 100 is received in the receiving cavity 15 of the housing 82 and then the CPU 100 and the housing 82 are sandwiched by the clip 84 and the reinforcement 83, the clip 84 and the lever 86 are pivotally mounted on the reinforcement 83 respectively and the securing portion 85 of the lever 86 presses the lip 841 of the clip 84. In process which the securing portion 85 pivotally presses the lip 841, the securing portion 85 exerts a horizontal pulling force (not shown) and a downward pressing force (not shown) on the clip 84, then the horizontal pulling force and the downward pressing force are exerted on the CPU 100 in virtue of the clip 84. The horizontal pulling force pulls the CPU 100 to move toward one side of the housing 82 adjacent to the securing portion 85 and to abut against the one side of the housing 82.

Referring to FIG. 7, when the downward pressing force presses downwardly the CPU 100, a upward friction between the CPU 100 and the one side of the housing 82 adjacent to the securing portion 85 is produced and the upward friction counteracts a part of the downward pressing force so that the downward pressing force can't reliably press downwardly the CPU 100 to make the CPU 100 move downwardly to electrically connect with the contacts 81, especially the contacts located at corners 80, 88 of the housing 82, thus affecting signal transmission between the CPU 100 and the contacts 81.

Hence, an improved LGA connector assembly is required to overcome the disadvantages of the prior art.

### SUMMARY OF THE INVENTION

An object of the present invention is to provide a land grid array (LGA) connector assembly which can make an electrical package such as a LGA central processing unit (CPU) electrically and reliably connect with electrical contacts thereof.

Another object of the present invention is to provide a LGA connector assembly which can decrease friction between the CPU and an insulative housing of the LGA connector.

Accordingly, to achieve above-mentioned object, a land grid array (LGA) connector assembly for electrically connecting with an electrical package comprises an insulative housing having a mounting face and a mating face opposite to the mounting face; a plurality of electrical contacts received in the housing; a reinforcement attached to the mounting face of the insulative housing and defining an aperture in middle thereof for exposing the soldering portions of the electrical contacts; a clip hinged with the reinforcement on a rear edge thereof and pivotable between an open position and a final position, the clip attached adjacent to the mating face of the insulative housing to define a receiving cavity therebetween adapted to receiving the electrical package therebetween in the open position and establish an electrical connection between the electrical package and the electrical contacts in the final position, the clip formed with at least a resilient portion projecting toward the insulative housing adjacent to the front edge thereof and a pressing portion curving toward the insulative housing at middle portion thereof along a front-rear direction; and a lever pivotally mounted in the reinforcement and comprising a securing portion for pressing the clip.

The detailed features of the present invention will be apparent in the detailed description with appropriate reference to the accompanying drawings.

### BRIEF DESCRIPTION OF THE DRAWINGS

FIG. 1 is an exploded perspective view of the LGA connector assembly and the CPU in accordance with the present invention;

FIG. 2 is a plane view of a clip of the LGA connector assembly of FIG. 1;

FIG. 3 is an assembled perspective view of the LGA connector assembly and the CPU of the FIG. 1; and

FIG. 4 is a cross-sectional view taken along line 4-4 shown in FIG. 3.

FIG. 5 is an exploded perspective view of a conventional land grid array (LGA) connector assembly and a LGA central processing unit (CPU);

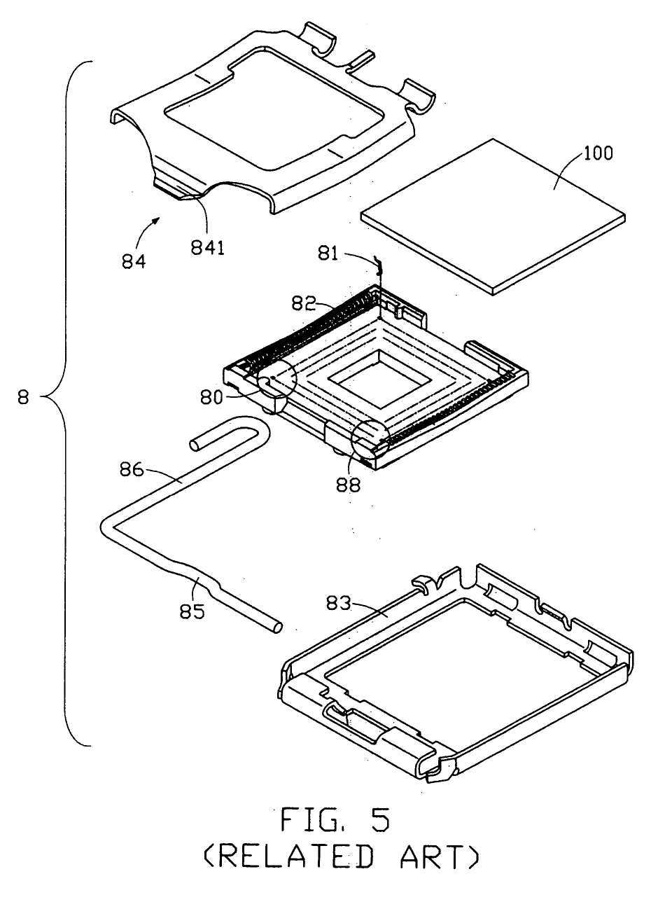

FIG. 6 is an assembled perspective view of the LGA connector assembly and the CPU of FIG. 5;

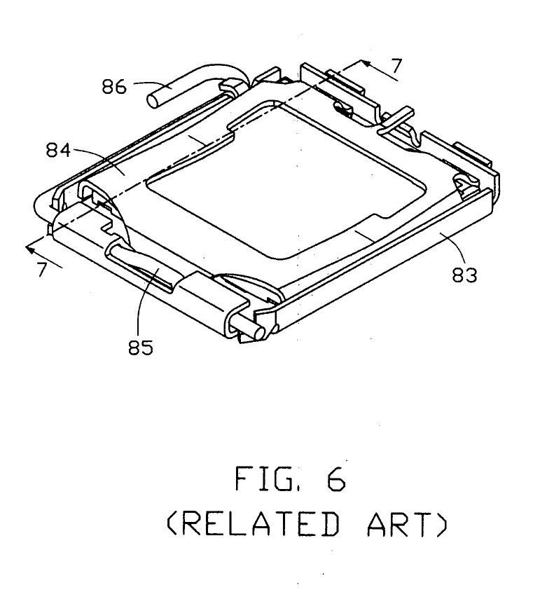

FIG. 7 is a cross-sectional view taken along line 7-7 shown in FIG. 6;

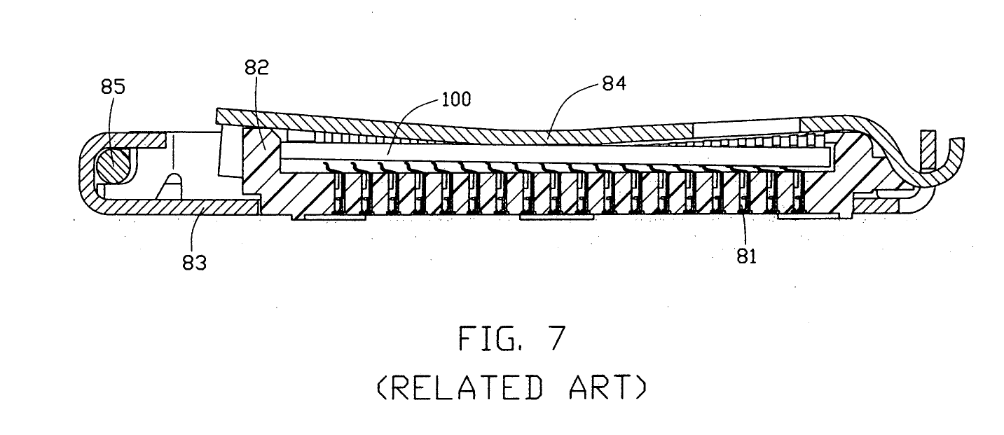

### DETAILED DESCRIPTION OF THE INVENTION

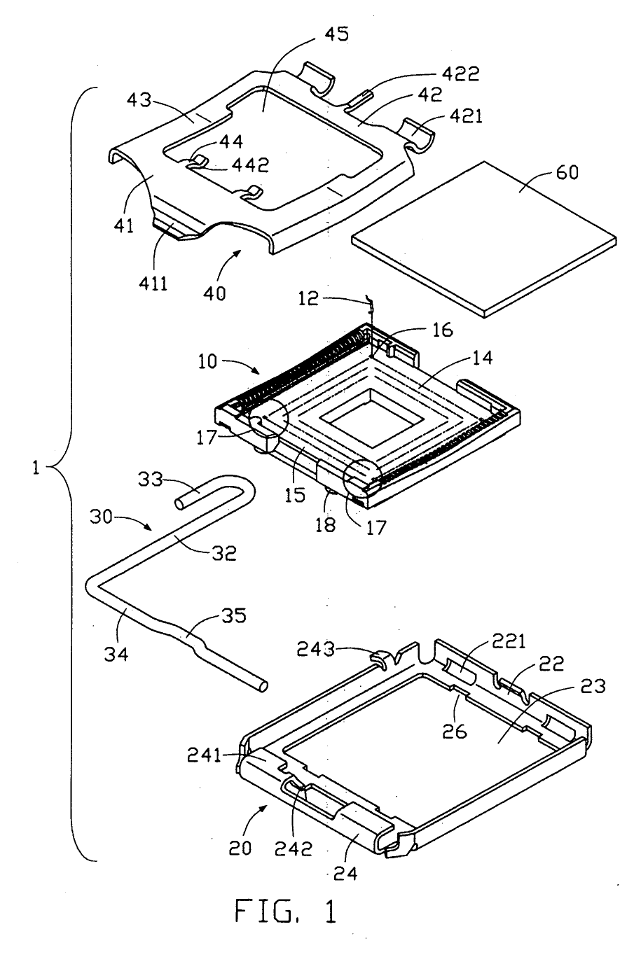

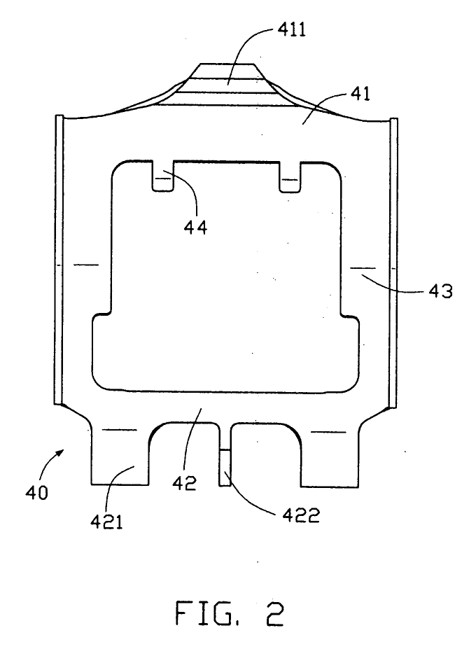

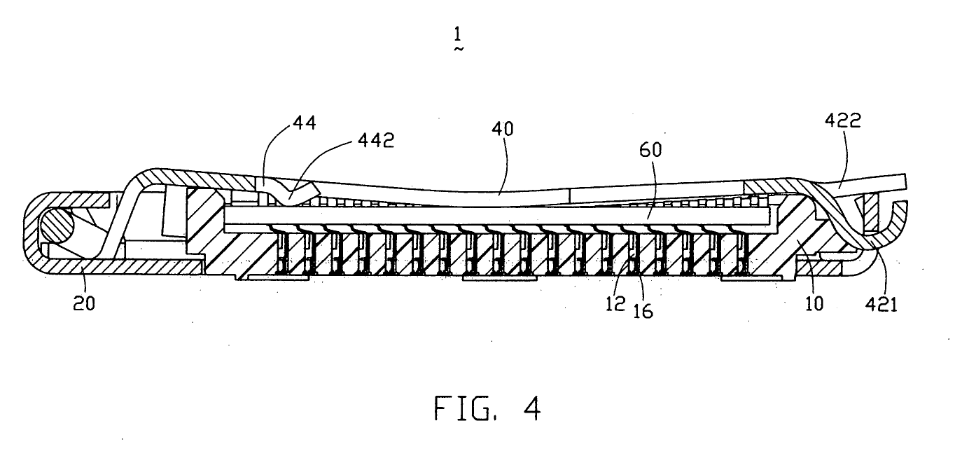

Referring to FIGS. 1, 2, 3 and 4, a land grid array (LGA) connector assembly 1 in accordance with the present invention is adapted for electrically connecting an electrical package such as a LGA central processing unit (CPU) 60 with a circuit substrate such as a printed circuit board (PCB) (not shown).

The LGA connector assembly 1 comprises an insulative housing 10, a plurality of electrical contacts 12 received in the housing 10, a reinforcement 20 surrounding the housing 10 and joined with the housing 10 as a housing assembly, and a lever 30 and a metal clip 40 pivotally mounted on two opposite sides of housing 10 respectively.

The housing 10 is substantially rectangular. The housing 10 comprises a mounting face (not shown) and a mating face (not shown) opposite to the mounting face and defines a rectangular receiving cavity 15 in middle of the mating face and positioning blocks 18 on the mounting face thereof. A portion 14 of the housing 10 under the receiving cavity 15 is provided with a plurality of receiving passages 16 for receiving the contacts 12. Engaging portions (not shown) of the contacts 12 extend into the cavity 15 to electrically connect with the CPU 60 and soldering portions (not shown) of the contacts 12 are soldered on the PCB, thus accomplishing electrical connection between the CPU 60 and the PCB.

The lever 30 is approximately column and comprises an operating portion 32 and a locating portion 34 perpendicular to the operating portion 32. A handle 33 extends bendly from a free end of the operating portion 32 and the locating portion 34 is provided with an offset securing portion 35 in middle thereof.

The clip 40 is stamped and formed from a sheet of metallic material. The clip 40 defines a space 45 in middle thereof. A lip 411 is formed on front edge 41 of the clip 40 and the clip 40 is provided with a pair of spaced mounting portions 421 extending arcuately from a rear edge 42 opposite the front edge 41 thereof and defines pressing portions 43 curving toward the insulative housing 10 at a middle portion thereof along a front-rear direction. In use, the pressing portions 43 of the clip 40 are attached adjacent to the mating face of the insulative housing 10 and press downwardly the CPU 60. The clip 40 defines a pair of resilient portion 44 extending from the edge 41 adjacent to the offset securing portion 35 of the lever 30 to the space 45 defined therein and projecting towards the housing 10. Each of resilient portions 44 is approximately in shape of “V” and comprises a contacting portion 442 for pressing the CPU 60.

The reinforcement 20 is approximately rectangular. The reinforcement 20 for attaching to the mounting face (not shown) of the insulative housing 10 comprises an aperture 23 in a central portion for exposing the soldering portions (not shown) of the contacts 12 and sides walls extending upwardly from edges of the aperture 23. The side wall 22 of the reinforcement 20 is provided with a pair of slots 221 corresponding to the mounting portions 421 of the clip 40 and the side wall 24 opposite the side wall 22 defines a pair of blocking pieces 241, and a securing piece 242 is formed on one of the blocking pieces 241. The blocking pieces 241, the securing 242 and ends of the other two side walls of the reinforcement 20 make the lever 30 pivotally mount in the side wall 24 and locked by a ear 243 formed on one side wall connecting the side walls 22 and 24. The edges of the aperture 23 are provided with grooves 26 adjacent to the side wall 22 and the side wall 24 opposite the side wall 22 respectively, corresponding to the positioning blocks 18 of the housing 10.

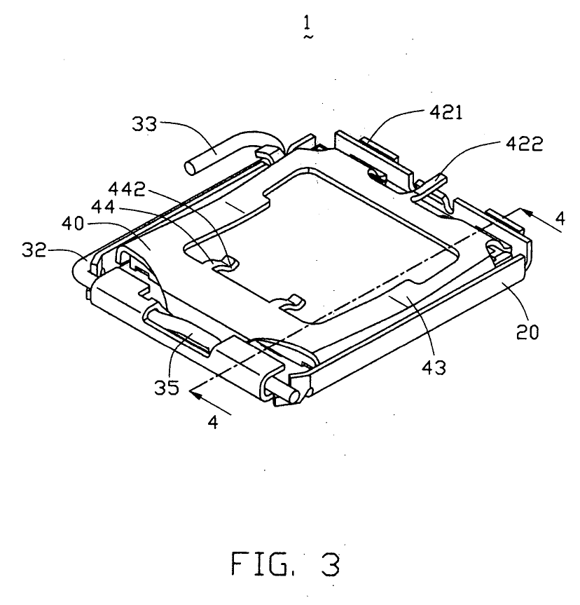

Referring to FIG. 3, when assembled, the clip 40 and the lever 30 are pivotally mounted on the side wall 22 and the side wall 24 opposite the side wall 22 respectively, then the housing 10 is set in the aperture 23 of the reinforcement 20 and surrounded by the reinforcement 20, and the housing 10 is secured in the reinforcement 20 by engagement of the positioning blocks 18 thereof and the grooves 26 of the reinforcement 20.

In use, the clip 40 and the lever 30 are oriented perpendicular to the housing 10 in an open position, with the offset securing portion 35 disposed above the locating portion 34 and the mounting portions 421 of the clip 40 hinged in the slots 221 of the reinforcement 20. The CPU 60 is mounted in the cavity 15 with the CPU 60 loosely attached on the contacts 12 of the LGA connector assembly 1. The clip 40 is rotated downwardly to the mating face of the housing 10 and loosely contacted with the CPU 60. Then the operating portion 32 of the lever 30 is rotated downwardly, thus rotating the securing potion 35 downwardly. When the securing portion 35 reaches the lip 411 of the clip 40, it engages with the lip 411 and drives the lip 411 downwardly. The operating portion 32 is rotated further downwardly until the operating portion 32 is engaged under the ear 243 of the reinforcement 20. The ear 243 holds the operating portion 32 at a horizontal position defined as a final position. In this position, the securing portion 35 of the lever 30 tightly presses the lip 411 of the clip 40, the resilient portion 44 and the pressing portion 43 of the clip 40 are in turn tightly pressing the CPU 60 on the contacts 12. Because of an additional downward pressing force produced by the resilient portion 44, the overall downward pressing force is increased. The LGA connector assembly 1 thus electrically connects the CPU 60 and the PCB reliably.

When the securing portion 35 presses downwardly on the lip 411 of the clip 40, the contacting portions 442 of the resilient portions 44 of the clip 40 are pressing downwardly the CPU 60, thus increasing the downward pressing force exerted on the CPU 60, especially on a portion of CPU 60 at corners 17 of the housing 10 adjacent to the securing portion 35. Because the pressing force exerted on the CPU 60 is increased, it is reliable to press downwardly the CPU 60 to electrically connect with the contacts 12 located at corners 17 of the housing.

The disclosure is illustrative only, changes maybe made in detail, especially in matter of shape, size, and arrangement of parts within the principles of the invention. For example, it would be doable that the clever 30 and clip 40 are both pivotally mounted on the housing 10.

1. A land grid array (LGA) connector assembly for electrically connecting with an electrical package, comprising:
an insulative housing having a mounting face and a mating face opposite to the mounting face;
a plurality of electrical contacts received in the housing;
a reinforcement attached to the mounting face of the insulative housing and defining an aperture in middle thereof for exposing soldering portions of the electrical contacts;
a clip hinged with the reinforcement on a rear edge thereof and pivotable between an open position and a final position, the clip attached adjacent to the mating face of the insulative housing to define a receiving cavity therebetween adapted to receiving the electrical package therebetween in the open position and establish an electrical connection between the electrical package and the electrical contacts in the final position, the clip formed with at least a resilient portion projecting toward the insulative housing adjacent to the front edge thereof and a pressing portion curving toward the insulative housing at middle portion thereof along a front-rear direction; and
a lever pivotally mounted in the reinforcement and comprising a securing portion for pressing the front edge of the clip.

2. The LGA connector assembly as described in claim 1, wherein the resilient portion is in shape of “V”.

3. The LGA connector assembly as described in claim 1, wherein the lever comprises an operating portion and a locating portion perpendicular to the operating portion, and the securing portion is formed in a middle of the locating portion.

4. The LGA connector assembly as described in claim 1, wherein the resilient portion comprises a contacting portion for contacting with the electrical package.

5. The LGA connector assembly as described in claim 1, wherein the lip extends opposite to the resilient portion and extends outwardly from the front edge of the clip adjacent to the securing portion.

6. The LGA connector assembly as described in claim 1, wherein the housing comprises positioning blocks formed on the mounting face thereof engaging with grooves of the reinforcement.

7. The LGA connector assembly as described in claim 1, wherein the clip comprises a pair of mounting portions extending arcuately from the rear edge thereof.

8. A land grid array (LGA) connector assembly comprising:
a housing assembly defining an upward cavity;
a plurality of conductive contacts disposed in the housing with upper contacting portions extending upwardly into the cavity;
a clip defining a front-to-back direction with one end pivotally assembled to said housing assembly;
a lever assembled to the housing assembly and latchably engaged with the other end of the clip; and
an electronic package received in the cavity, and electrically and mechanically engaged with the upper contacting portions; wherein
said clip is downwardly curved to form a pressing portion around a middle portion thereof in said front-to-back direction to downwardly press against a middle area of the electronic package, and said clip is further equipped with at least one spring tang to downwardly press against a periphery portion of the electronic package.

9. The LGA connector assembly as described in claim 8, wherein said spring tang is located around the other end of the clip.

10. The LGA connector assembly as described in claim 8, wherein said clip defines an opening, and said spring tang extends from an edge of said opening toward a center portion of the opening.

11. The LGA connector assembly as described in claim 8, wherein said housing assembly includes an insulative housing.

12. The LGA connector assembly as described in claim 1, wherein said housing assembly further includes a reinforcement surrounds the insulative housing.

13. A land grid array (LGA) connector assembly comprising:
a housing assembly defining an upward cavity;
a plurality of conductive contacts disposed in the housing with upper contacting portions extending upwardly into the cavity;
a metallic clip defining a front-to-back direction with one end pivotally assembled to said housing assembly;
a lever fixing the clip to the housing assembly; and
an electronic package received in the cavity, and electrically and mechanically engaged with the upper contacting portions; wherein
said clip is downwardly curved to form a pressing portion around a middle portion thereof in said front-to-back direction to downwardly press against a middle area of the electronic package, and said clip is further equipped with at least one spring tang to downwardly press against a boundary area of the electronic package which is far away from the middle area in said front-to-back direction.

14. The LGA connector assembly as described in claim 13, wherein said spring tang is located around the other end of the clip.

15. The LGA connector assembly as described in claim 13, wherein said clip defines an opening, and said spring tang extends from an edge of said opening toward a center portion of the opening.

16. The LGA connector assembly as described in claim 13, wherein said housing assembly includes an insulative housing.

17. The LGA connector assembly as described in claim 16, wherein said housing assembly further includes a reinforcement surrounds the insulative housing.
